(19) United States
(12) Patent Application Publication
(10) Pub. No.: US 2022/0399539 A1
(43) Pub. Date: Dec. 15, 2022

(54) DRY ELECTRODE MANUFACTURING

(71) Applicant: Volkswagen Aktiengesellschaft, Wolfsburg (DE)

(72) Inventor: Bastian Westphal, Braunschweig (DE)

(21) Appl. No.: 17/777,263

(22) PCT Filed: Nov. 21, 2019
(86) PCT No.: PCT/EP2019/082096

§ 371 Date: May 16, 2022

(51) Int. Cl. H01M 4/36; H01M 4/04; H01M 4/1393

(52) U.S. Cl. CPC H01M 4/366; H01M 4/0419; H01M 4/1393; H01M 4/0435; H01M 10/0525

(57) ABSTRACT

Technologies and techniques for the dry manufacture of an electrode. A substrate is provided, and a primer material is dispensed on the substrate to provide a primer layer on the substrate, dispensing an electrode material on the primer layer and attaching the electrode material via pressure and/or temperature to provide an electrode material layer.

### RELATED APPLICATIONS

The present application claims priority to International Patent App. No. PCT/EP2019/082096 to Bastian Westphal, titled “Dry Electrode Manufacturing”, filed Oct. 21, 2019, the contents of which is incorporated by reference in its entirety herein.

### TECHNICAL FIELD

The present disclosure is directed to technologies and techniques for the dry manufacture of an electrode.

### BACKGROUND

Lithium-ion battery electrodes of the prior art are manufactured by wet coating a conductive substrate with a slurry of active material. The preparation of electrodes by dry coating a primer-layered substrate with active material has also been investigated. However, it is necessary that the substrate is layered with a primer layer to ensure adhesion of the dry-coated active material. The primer layer additionally improves conductivity and the resistance properties between the substrate and the active material and further functions as a protective barrier of the substrate.

The primer layer is comprised of conductive carbon material, such as graphite and carbon black. The primer layer is prepared in a separate process by wet coating the substrate with a slurry comprising the primer material, solvent and binder. The preparation of the primer layered substrate is known from U.S. Pat. No. 6,627,252 B1.

The preparation of the primer-layered substrate does, however, require an additional, separate process step that is not compatible with a subsequent dry-coating step of the active material, thus making it difficult to integrate both process steps and the primer layer needs to be prepared separately.

Therefore, it was an object of the present disclosure to provide an improved process for preparing an electrode with a thin primer layer that is more efficient in terms of time and costs, more environmentally friendly, requires less space and fewer process steps and can be integrated in the facilities used for dry coating the active material.

### SUMMARY

In some examples, a method is disclosed for the dry manufacture of an electrode, comprising the steps of: providing a substrate, dispensing a primer material on the substrate to provide a primer layer on the substrate, dispensing an electrode material on the primer layer, and attaching the electrode material by means of pressure and/or temperature to provide an electrode material layer.

The primer layer may be formed by dispensing the primer material on the substrate. This step omits the necessity to first prepare a slurry of primer material, binder and solvent, then apply the slurry to one surface of the substrate sheet, drying the slurry by heat and then repeating the steps on the second surface of the substrate sheet.

In some examples, the method may also include coating of the primer material and coating of the active material in one process unit. The prior art process additionally requires rolling up the primer layered substrate sheet for transport in a different process facility and subsequent unrolling. Thus, the process of the present disclosure is more efficient. Alternately or in addition, the technologies and techniques provided in the present disclosure lead to a more environmentally friendly process, as no potentially harmful solvents, such as acetone or N-methyl-2-pyrrolidone (NMP), are employed.

In some examples, an electrode is disclosed, wherein the electrode is configured according to any of the processes of the present disclosure.

In some examples, an energy storage device is disclosed, wherein the energy storage device is configured according to any of the processes of the present disclosure.

### BRIEF DESCRIPTION OF THE DRAWINGS

Aspects of the present disclosure will be explained on the basis of exemplary embodiments with reference to the drawings:

FIG. 1 illustrates a system and process for forming primer layers and electrode material on a substrate sheet according to some aspects of the present disclosure;

FIG. 2 illustrates another system and process for forming primer layers and electrode material on a substrate sheet according to some aspects of the present disclosure; and

FIG. 3 illustrates a further system and process for forming primer layers and electrode material on surfaces of a substrate sheet according to some aspects of the present disclosure.

### DETAILED DESCRIPTION

The following definitions are relevant in connection with the embodiments of the present invention.

In some examples, the substrate may be a conductive material. Non-limiting examples of the substrate are compositions comprising aluminum, copper, nickel and/or titanium. It is preferred that the substrate is comprised of aluminum due to the high strength and good conductivity of aluminum. The substrate can have any form but is commonly provided in the form of sheets or foils. The substrate can also be in the form of a batting material or expanded metal material. The thickness of these sheets is around 4 to 30 μm. Foils considerably thinner than 4 μm are prone to damage, more difficult to manufacture and have an increased resistance.

The meaning of the term “comprising” is to be interpreted as encompassing all the specifically mentioned features as well as optional, additional, unspecified ones, whereas the term “consisting of” only includes those features as specified. Therefore, “comprising” includes as a limiting case the composition specified by “consisting of”.

As used herein, the expression “dry manufacture of an electrode” refers to a process that uses dry coating for the preparation of the primer layer as well as the electrode material layer. In contrast to wet coating, the respective particles are not first solved or dispersed in solvent but directly dispensed. Thus, dry manufacture refers to a process in which no or substantially no solvent is used. Nevertheless, it is to be understood that even during dry manufacturing of the electrode the materials may contain some residual solvent and/or moisture as impurity or absorption from the surroundings.

The expression “attaching by means of pressure and/or temperature” may also include lamination of the primer layered substrate with electrode material, wherein the electrode material is primarily attached by fibrillization of the second binder. In the context of this application, the term “pressure” is to be understood to encompass shear stress.

The term “dispensed” and variants thereof as used herein, are to be understood in a broad manner to encompass the application methods of depositing, casting, coating, laminating, spraying, etc.

Preferred embodiments according to the invention are defined hereinafter. The preferred embodiments are preferred alone or in combination. Further, it is to be understood that the following preferred embodiments refer to all aspects of the present invention, e.g., the process for preparing the electrode, the electrode obtainable by such a process and the energy storage device comprising the electrode.

FIG. 1 illustrates a system and process for forming primer layers and electrode material on a substrate sheet according to some aspects of the present disclosure. The substrate sheet (10) moves through the different steps in direction of the arrow. First, the primer material (20) is deposited on a first substrate surface (12) by electrostatic deposition from a capacitator plate (18) to form a first primer layer (22). The substrate is deflected by deflection rolls (30) and subsequently primer material is deposited on the second substrate surface (14) to form a second primer layer (24). The electrode material (40) is then simultaneously dispensed on and attached to/fibrillized on the first and the second primer layers (22, 24) by two pairs of calender rolls (32). Optionally, the electrode material layer (40) is further compressed by an additional pair of counter-rotating calender rolls (34).

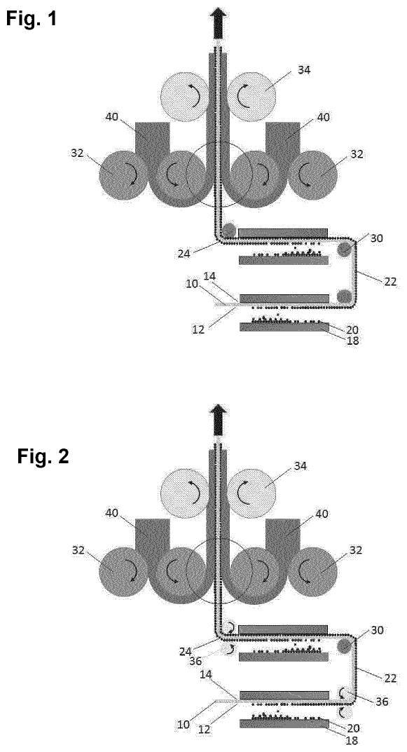

In the example of FIG. 2, the primer material (20) is deposited on a first substrate surface (12) by electrostatic deposition from a capacitator plate (18) and then compressed by a pair of calender rolls (36) to form a first primer layer (22). The substrate is deflected by a deflection roll (30) and subsequently primer material (20) is deposited on the second substrate surface (14) and then compressed by a pair of calender rolls (36) to form a second primer layer (24). The electrode material (40) is then simultaneously dispensed on and attached to/fibrillized on the first and the second primer layers (22, 24) by two pairs of calender rolls (32). Optionally, the electrode material layer (40) is further compressed by an additional pair of counter-rotating calender rolls (34).

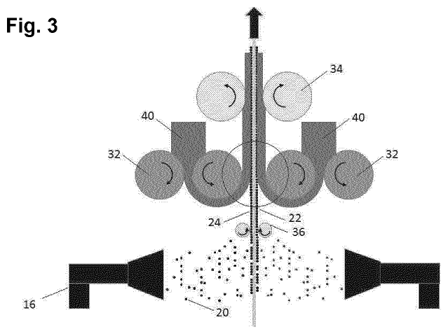

FIG. 3 depicts the process comprising electrospray deposition. The primer material (20) is simultaneously deposited on the first substrate surface (12) and the second substrate surface (14) by electrospray deposition (16) and then optionally compressed by a pair of calender rolls (36) to form the first and the second primer layers (22, 24). The electrode material (40) is then simultaneously dispensed on and attached to/fibrillized on the first and the second primer layers (22, 24) by two pairs of calender rolls (32). Optionally, the electrode material layer (40) is further compressed by an additional pair of counter-rotating calender rolls (34).

In one embodiment, the primer material may be dispensed as solid particles, by electrostatic deposition, preferably by deposition from capacitor plates or by electrostatic spraying. In a particularly preferred embodiment, the primer material is dispensed by corona or triboelectric dispensing.

Electrostatic deposition is a technique employed for the thin deposition of particle layers by ionizing the particles, such as by corona ionization or by triboelectric friction. The particles are then deposited on the substrate. In contrast to techniques such as plasma-enhanced chemical vapour deposition (PECVD), the particles are deposited in solid form. In a preferred embodiment, the deposition takes place by electrostatic spray deposition (ESD). ESD involves the formation of a charged aerosol of primer material that is then directed to the substrate by an electric field.

In an even more preferred embodiment, the deposition takes place from capacitor plates.

In some examples, the primer layer may have a thickness of from 10 nm to 5 μm, preferably of from 0.05 μm to 1 μm. In principle, the primer layer thickness can be as low as one particle layer of the primer particle. In one embodiment, the layer thickness is of from 10 nm to 5 μm, from 10 nm to 4 μm, from 10 nm to 3 μm, from 10 nm to 2 μm, from 10 nm to 1 μm, from 10 nm to 0.1 μm. In another embodiment, the layer thickness is of from 50 nm to 5 μm, from 0.1 μm to 5 μm, from 1 μm to 5 μm. It is preferred that the layer thickness is lower than 5 μm. It is even more preferred that the primer layer has a thickness of from 10 nm to 1 μm. In a particularly preferred embodiment, the primer layer has a thickness of from 0.1 to 1 μm. It is noted that the thickness of the primer layer refers to the thickness of the obtained electrode.

In some examples, the primer material may be selected from the group consisting of graphite, carbon black, graphene, carbon nanotubes, fullerenes, a first binder and mixtures thereof. In a preferred embodiment, the primer material comprises graphite and/or carbon black. In an embodiment, the primer material comprises 50 to 100 wt.-% of carbon material selected from the group consisting of graphite, carbon black, graphene, carbon nanotubes, fullerenes and mixtures thereof, and 0 to 50 wt.-% of the first binder. In a preferred embodiment, the primer material consists of 70 to 100 wt.-% of carbon material selected from the group consisting of graphite, carbon black, graphene, carbon nanotubes, fullerenes and mixtures thereof, and 0 to 30 wt.-% of the first binder. In another embodiment, the primer material contains no binder.

The first binder may be comprised of a polymer binder. Suitable polymer binders are polyethylene (PE), methyl cellulose, fluoroelastomers, poly(vinylacetate), polyurethanes, poly(acrylic acid), poly(methacrylic acid) and mixtures thereof. Non-limiting examples of fluoroelastomers comprise polyvinylidene fluoride (PVdf), polytertrafluoroethylene (PTFE) and polyhexafluoropropylene. The polymer can be a monopolymer or a copolymer. The copolymers comprise statistical copolymers, gradient copolymers, alternating copolymers, block copolymers and branching copolymers. It is preferred that the first binder comprises polyvinylidene fluoride and/or polytertrafluoroethylene (PTFE). It is particularly preferred that the first binder comprises polyvinylidene fluoride.

In some examples, the primer material may have an average particle size (D50) of from 1 to 500 nm, preferably from 10 to 300 nm, more preferably from 50 to 200 nm. In an embodiment, the primer material has an average particle size (D50) of from 1 to 400 nm, 1 to 300 nm, 1 to 200 nm, 10 to 500 nm, 10 to 400 nm, 10 to 300 nm, 10 to 200 nm, 10 to 100 nm, 50 to 500 nm, 50 to 400 nm, 50 to 300 nm or 50 to 200 nm. It is preferred that the particle size is from 50 to 200 nm. The particle size can be determined by laser diffraction, such as ISO 13320:2009 or dynamic light scattering methods. The above particle size of the primary material refers to the primary particle size. It is, however, also possible that the primary particles form agglomerates with a secondary particle size of up to 2 μm.

In some examples, the electrode material may include active material, a second binder and/or an additive. In one examples, the electrode material comprises 60 to 100 wt.-% active material and 0 to 30 wt.-% of the second binder and 0 to 10 wt.-% of additive. In a preferred embodiment the electrode material comprises 90 to 100 wt.-% active material and 0 to 10 wt.-% of the second binder.

Suitable active materials are disclosed in “Principles and Applications of Lithium Batteries”, J. Park, 1^{st} edition, 2012, Wiley-VCH Verlag and “Handbook of Battery Materials”, C. Daniel, J. Besenhard, 2^{nd} edition, 2011, Wiley-VCH Verlag. The active material may be an anode or a cathode active material. It is preferred that the active material is a cathode active material.

The anode active material can be divided into intercalation-based materials, such as graphite, conversion-reaction based materials and alloying-reaction based materials.

The cathode active material can be divided into layered structure compounds, spinel and inverse spinel composites, olivine composites, vanadium composites and mixtures thereof.

Non-limiting examples of layered structure compounds comprise LCO (LiCoO₂), LNO (LiNiO₂), LMO (LiMnO₂), LTO (Li₃₋ₓMₓN; M=Co, Ni or Cu, 0.1<x<0.6), LiFeO₂, NMC (Ni—Mn—Co three component systems, such as Li[NiₓMnₓCo₁₋₂ₓ]O₂, 0<x<0.5, preferably LiN_{1/3} Mn_{1/3}Co_{1/3}O₂(NMC 333) and NCA (Ni—Mn—Al three component systems, such as LiNi_{0.8}Co_{0.15}Al_{0.05}) Further Non-limiting examples of NMCs comprise LiNi_{8/10}Mn_{1/10}Co_{1/10}O₂ (NMC 811), LiNi_{9/10}Mn_{0.5/10}Co_{0.5/10} O₂ (NMC 9/0.5/0.5) LiNi_{6/10}Mn_{2/10}Co_{2/10}O₂ and (NMC 622). In a preferred embodiment, the electrode active material comprises NMC 622.

Non-limiting examples of spinel and inverse spinel composites comprise LMO (LiMn₂O₄), LiTi₂O₄, LiV₂O₄ and LiNiVO₄.

Non-limiting examples of olivine composites comprise LFP (LiFePO₄) and LiFe₁₋ₓMₓPO₄ (0<x<1; M=Mn, Co, Ni).

Non-limiting examples of vanadium composites comprise V₂O₅, V₂O₃, VO₂, V₆O₁₃, V₄O₉, V₃O₇, Ag₂V₄O₁₁, AgVO₃, Li₃V₃O₅, □—NH₄V₄O₁₀, Mn_{0.8}V₇O₁₆, LiV₃O₈, CuₓV₂O₅ (0<x<0.3) and CrₓV₆O₁₃ (0<x<0.1).

In some examples, the active material may include NCA, LCO, LNO, NMC, LTO, LMO or mixtures thereof. A preferred mixture of the above composites is a NMC-LMO mixture.

The second binder may be comprised of polyvinylidene fluoride (PVdf), polyhexafluoropropylene, polytetrafluorethylene (PTFE; Teflon®), polyethylene (PE) or mixtures or copolymers thereof. In a preferred embodiment the second binder is polytetrafluorethylene.

The additive may be configured as a conductive carbon. In a preferred embodiment the additive is comprised of graphite, carbon black, carbon nanotubes, graphene. fullerenes or mixtures thereof. In a preferred embodiment, the additive comprises graphite and/or carbon black.

In another examples, the electrode material layer may be configured with a density of from 3.0 to 4.0 g/cm³, preferably of from 3.2 to 3.8 g/cm³.

In another example, the electrode material layer may be configured with a thickness of from 50 to 200 In another example, the electrode material layer has a thickness of from 20 to 500 μm, from 30 to 400 μm or from 40 to 300 μm. In a preferred embodiment, the electrode material layer has a thickness of from 70 to 300 μm. In a particularly preferred embodiment, the electrode material layer has a thickness of from 70 to 150 μm. In case a first electrode material layer and a second material layer are present, the above thicknesses also apply to the first and second electrode material layers, respectively. It is noted that the thickness of the electrode material layer refers to the thickness in the obtained electrode.

In some examples, the step of dispensing a primer material on the substrate to provide a primer layer on the substrate may further comprises the step of attaching the primer material to the substrate by means of pressure and/or temperature, preferably by rolling with calender rolls or a counter-pressure roll.

In some examples, the step of attaching the electrode material by means of pressure and/or temperature to provide an electrode material layer may include attaching the electrode material by rolls, preferably using calender rolls or a counter-pressure roll.

In yet another embodiment, the substrate may include a first and a second surface, and the primer material is dispensed simultaneously or sequentially on the first and second surfaces to obtain a first and a second primer layer. The substrate is usually provided as a thin sheet, foil, batting material or expanded metal having a first and a second surface. With the process of the present disclosure, it is possible to form the primer layer simultaneously on the first and the second surfaces. It is, however, also possible to form a first primer layer on the first surface and then subsequently form a second primer layer on the second surface.

The same applies to the formation of the electrode material layer. In an embodiment that includes attaching the electrode material by means of pressure and/or temperature to provide an electrode material layer, the electrode material may be dispensed simultaneously on the first and the second primer layers, and when attaching the electrode material by means of pressure and/or temperature to provide an electrode material layer, the electrode material may be attached simultaneously to the first and the second primer layer. Thus, a first electrode material layer and a second electrode material layer are formed.

In some examples, the process may include the step of additionally compressing the electrode material layer(s). This additional compression can be performed by calender rolls or a counter-pressure roll. This additional compression step may be warranted to achieve an optimal electrode material layer density. As described above, densities of 3.2 to 3.8 g/cm³ are preferred.

In some examples, (i) attaching the electrode material by means of pressure and/or temperature to provide an electrode material layer, and (ii) attaching the electrode material by means of pressure and/or temperature to provide an electrode material layer may take place subsequently or simultaneously. Dispensing the electrode material and attaching the electrode material can take place at the same time. However, it is also possible to first dispense the electrode material on the primer layer and then subsequently attach the electrode material.

In some examples, the processes disclosed herein may be a continuous process. For efficiency purposes it is preferred that all steps of the process take place in a continuous way.

In some examples, the substrate may be configured as an aluminum sheet with a thickness of 5 to 30 μm. In a preferred embodiment the substrate is an aluminium sheet with a thickness of 8 to 15 μm.

In some examples, the electrode may be configured as a lithium ion battery electrode. In one example, the electrode is a cathode. It is preferred that the electrode is the cathode of a lithium ion battery.

1-15. (canceled)

16. A method for forming an electrode, comprising:
providing a substrate,
dispensing a primer material on the substrate to form a primer layer on the substrate,
dispensing an electrode material on the primer layer; and
attaching the electrode material on the primer layer using pressure and/or temperature to form an electrode material layer.

17. The method according to claim 16, wherein the primer material is dispensed as solid particles, by electrostatic deposition, deposition from capacitor plates or by electrostatic spraying.

18. The method according to claim 16, wherein the primer layer has a thickness range of 0.05 μm to 1 μm.

19. The method according to claim 16, wherein the primer material comprises at least one of graphite, carbon black, graphene, carbon nanotubes, fullerenes, a first binder and mixtures thereof.

20. The method according to claim 16, wherein the primer material comprises an average particle size (D50) of 10 to 300 nm.

21. The method according to claim 16, wherein the electrode material comprises active material, a second binder and/or an additive.

22. The method according to claim 16, wherein the electrode material layer has a density of 3.2 to 3.8 g/cm3.

23. The method according to claim 16, wherein the electrode material layer has a thickness of from 50 to 200 μm.

24. The method according to claim 16, wherein dispensing a primer material on the substrate further comprises attaching the primer material by rolling with calender rolls or a counter-pressure roll.

25. The method according to claim 16, wherein attaching the electrode material comprises attaching the electrode material by calender rolls or a counter-pressure roll.

26. The method according to claim 16, wherein the substrate comprises a first and a second surface, and the primer material is dispensed simultaneously or sequentially on the first and the second surface to obtain a first and a second primer layer.

27. The method according to claim 26, wherein the electrode material is dispensed simultaneously on the first and the second primer layer, and the electrode material is attached simultaneously to the first and the second primer layer.

28. The method according to claim 16, wherein the substrate comprises an aluminum sheet with a thickness of 5 to 30 μm.

29. An electrode, comprising
a substrate,
a primer material, dispensed on the substrate of the substrate to form a primer layer on the substrate; and
an electrode material layer, comprising an electrode material dispensed on the primer layer, wherein the electrode material is attached on the primer layer using pressure and/or temperature.

30. The electrode of claim 29,
wherein the primer material is dispensed as solid particles, by electrostatic deposition, deposition from capacitor plates or by electrostatic spraying,
wherein the primer material comprises an average particle size of 10 to 300 nm,
and wherein the primer material comprises at least one of graphite, carbon black, graphene, carbon nanotubes, fullerenes, a first binder and mixtures thereof.

31. The electrode of claim 29, wherein the electrode material layer has a density of 3.2 to 3.8 g/cm3.

32. The electrode of claim 29, wherein the electrode material comprises active material, a second binder and/or an additive.

33. The electrode of claim 29, wherein the electrode material layer has a density of 3.2 to 3.8 g/cm3, and wherein the electrode material layer has a thickness of from 50 to 200 μm.

34. The electrode of claim 29, wherein the substrate comprises a first and a second surface, and the primer material is dispensed simultaneously or sequentially on the first and the second surface to obtain a first and a second primer layer

35. An energy storage device, comprising:
an electrode, wherein the electrode comprises
a substrate,
a primer material, dispensed on the substrate of the substrate to form a primer layer on the substrate, wherein the primer material comprises at least one of graphite, carbon black, graphene, carbon nanotubes, fullerenes, a first binder and mixtures thereof; and
an electrode material layer, comprising an electrode material dispensed on the primer layer, wherein the electrode material is attached on the primer layer using pressure and/or temperature, and wherein the electrode material comprises active material, a second binder and/or an additive.
